(19) United States
(12) Patent Application Publication
(10) Pub. No.: US 2017/0133830 A1
(43) Pub. Date: May 11, 2017

(54) PLUGGABLE CABLE MANAGEMENT BOX WITH BUILT-IN SURGE PROTECTOR

(71) Applicant: Xung Van Ngo, Manassas, VA (US)

(72) Inventor: Xung Van Ngo, Manassas, VA (US)

(21) Appl. No.: 15/215,558

(22) Filed: Jul. 20, 2016

Related U.S. Application Data
(60) Provisional application No. 62/239,968, filed on Nov. 5, 2015.

(51) Int. Cl. H02G 3/18; H02G 3/08; H02G 3/10; H02H 9/00

(52) U.S. Cl. CPC H02G 3/18; H02H 9/005; H02G 3/081; H02G 3/10

(57) ABSTRACT

A cable management box with a built-in surge protector or an extension adaptor integrated so that it can be plugged into a standard duplex wall outlet as one unit. The surge protector can have one or two sets of plugs protruding out from the box. The surge protector middle screw and plugs will provide the necessary shear strength and grip to hold the entire box, adapters and cables within it. No wall screw is required.

### BACKGROUND OF THE INVENTION

The invention is a pluggable cable management box comprising a built-in surge protector or an outlet extension. For conciseness, the term ‘surge protector’ will be used to cover a true surge protector or any device in the form similar to a surge protector such as an outlet extension where there are outlets/receptacles and at least one set of plugs. Current cable management boxes do not have a built-in surge protector so owners had to purchase one. This scenario not only leads to extra cost but to an extra oversized surge protector cable sticking out of the box. Even worst, current cable management boxes just sit on the floor. The goal of cable management is to make an office appear neat and tidy. The invention resolves all these problems. First, to get the box off the floor it provides an easy plug and use method to hang the box onto a standard 16-inch high wall outlet without creating screw holes in the wall. Moreover, it eliminates the need to buy a surge protector since it is seamlessly designed into the cable box. Finally, there is no surge protector wire sticking out, making it a truly neat and tidy cable management box.

### DETAILED DESCRIPTION OF THE EMBODIMENTS

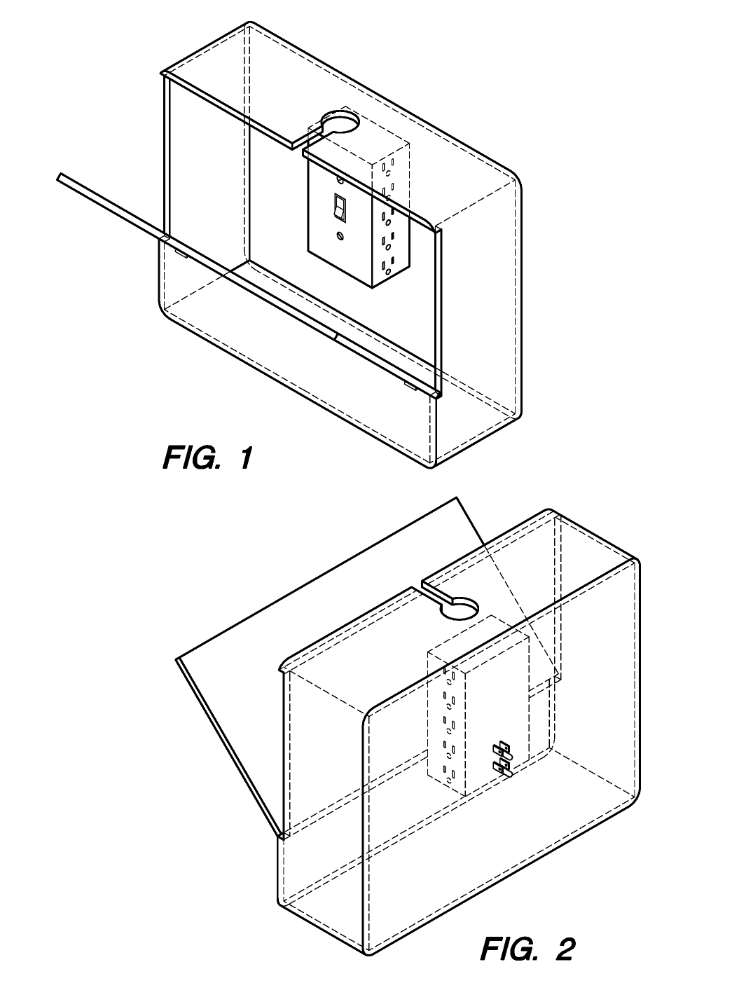

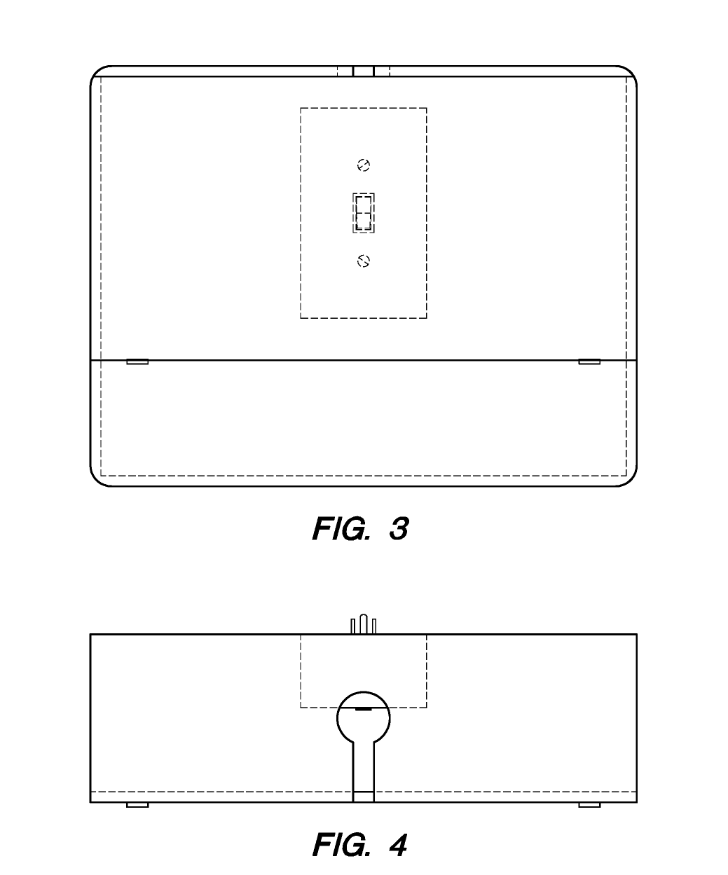

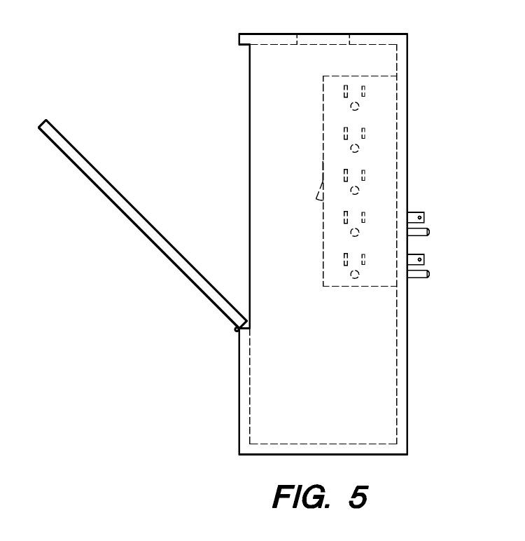

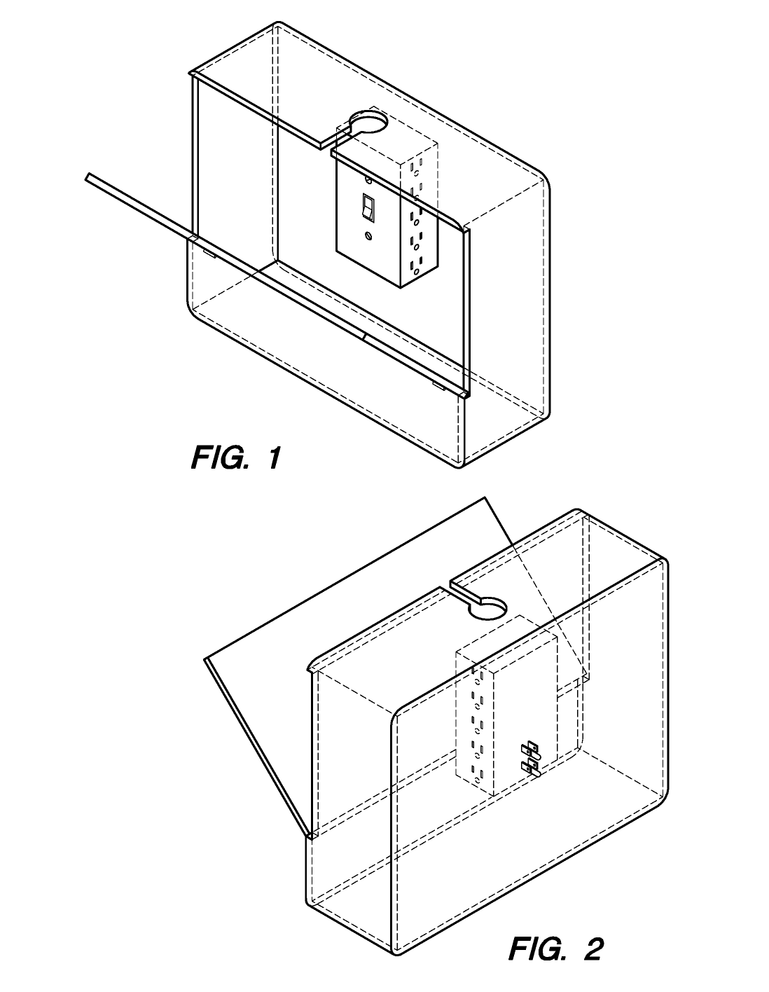

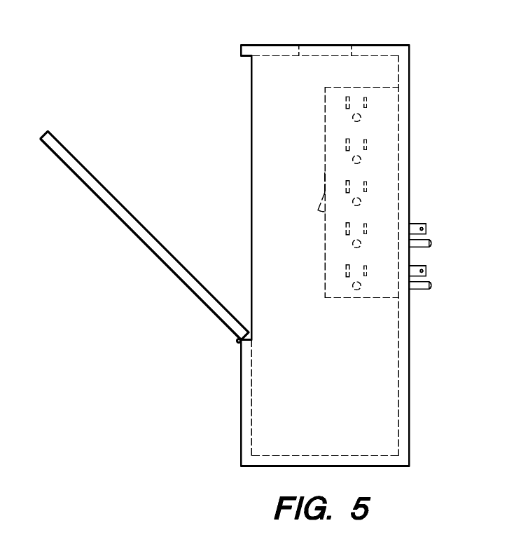

The main part of the box is the embodiment of the surge protector or an outlet extension. Best shown in FIG. 1 and FIG. 5, the box includes a surge protector securely attached to the center of the back wall. The surge protector encompasses two parts. The part that is the outlets/receptacles will be in the box but the part that includes the two three-prong plugs will be protruding through the back wall out of the box. The surge protector has multiple outlets/receptacles mirrored on both sides to allow for maximum usage. As a continuation of the surge protector the two three-prong plugs stick out from the back of the box. There is no wire. When plugged into a duplex wall outlet these plugs will provide the necessary shear strength and grip to hold the entire box, adapters and cables within it. For extra grip, a small screw may be tightened in the center of the surge protector to the outlet. This way the box will hang itself onto a standard duplex wall outlet without wall anchors/screws. This is the claim of the invention. The box itself can be made from heat resistance plastic that is light and cost efficient.

The invention also includes a pocket area that is below the surge protector to hold all the cables and adapters. By design this area is the largest open area of the box and is also where the bulk of the weight of the adapters and cables will be. The adapters and cables themselves are free to be situated in any positions as long as the male plugs find themselves to an outlet/receptacle and the opposite end finds their way out a cable opening.

In addition, the invention embodies at least one cable opening on the top and middle of the box. There will be a little slot opening that leads to a bigger round opening. This will allow for cables with large head plugs to go through. The final market unit may have multiple cable openings.

Finally, the invention includes a door or cover that serves to hide all the adapters, cables, and surge protector. When all the cables and adapters are situated soundly into the pocket of the box the door/cover can be snapped close to create an aesthetically tidy looking box.

### SUMMARY OF THE INVENTION AND CLAIMS

The invention of the cable management box comprising a built-in surge protector (or an outlet extension) will proves to be a better alternative to existing cable management boxes. The invention allows the cable box to easily plug into a standard wall outlet so that it hangs on the wall to create a neat and tidy office. It is a complete solution because there is no need to buy a surge protector.

Having described my invention, I claim:

1) A cable management box comprising a built-in surge protector (or an outlet extension) that has plugs protruding from the box.

### RELATED ART

FIG. 1: 3-dimensional frontal view of the cable management box as a whole and embodies; the entire cable box, the surge protector, the pocket area, and the door.

FIG. 2: 3-dimensional back view of the cable management box as a whole and embodies; the entire cable box, the surge protector (with the two three-prong plugs), the pocket area, and the door.

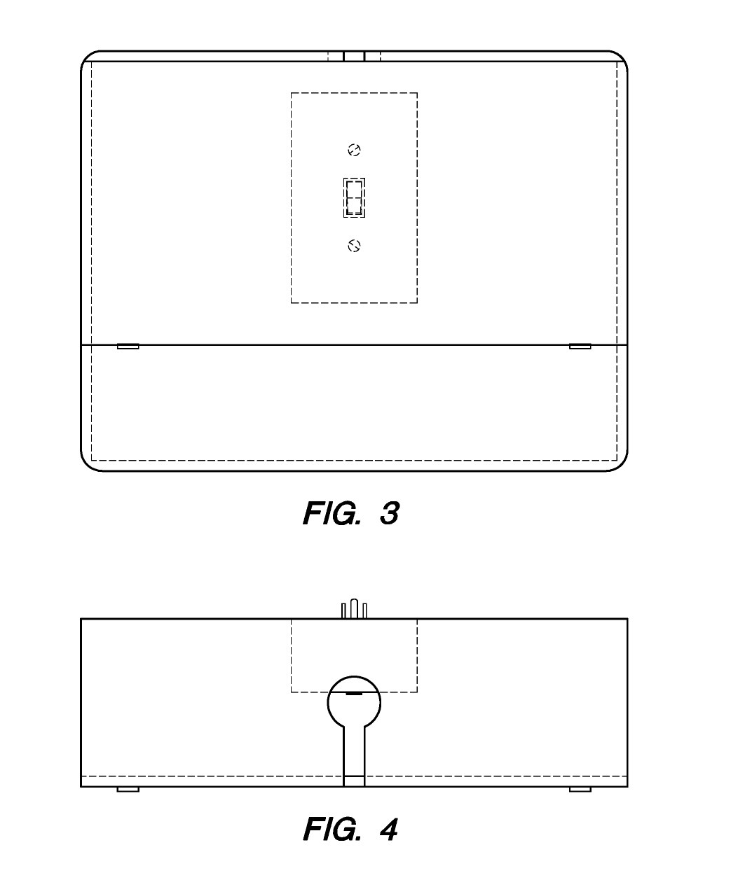

FIG. 3: Front view of the cable management box with the door closed showing inside surge protector.

FIG. 4: Top view of the cable management box showing the top opening, a narrow slot leading to a larger rounded opening.

FIG. 5: Side view of the cable management box as a whole showing; the entire cable box, the surge protector (with the two three-prong plugs), the pocket area, and the door.

1. A cable management box comprising a built-in surge protector (or an outlet extension) that has plugs protruding from the box.
